(19) United States
(12) Patent Application Publication
(10) Pub. No.: US 2019/0257266 A1
(43) Pub. Date: Aug. 22, 2019

(54) COMPRESSION SELF-IGNITED INTERNAL COMBUSTION ENGINE

(71) Applicant: TOYOTA JIDOSHA KABUSHIKI KAISHA, Toyota-shi (JP)

(72) Inventors: Isamu GOTO, Susono-shi (JP); Keisuke TANAKA, Susono-shi (JP)

(73) Assignee: TOYOTA JIDOSHA KABUSHIKI KAISHA, Toyota-shi (JP)

(21) Appl. No.: 16/223,640

(22) Filed: Dec. 18, 2018

(30) Foreign Application Priority Data
Feb. 16, 2018 (JP) 2018-026201

(51) Int. Cl. F02F 3/14; F02B 23/06

(52) U.S. Cl. CPC F02F 3/14; F02B 23/0672

(57) ABSTRACT

A heat shield film M1 is formed on entire are of the side surface 20b. A heat shield film M2 is formed entire area of the top surface 12a and the bottom surface 20c. The heat shield films M1 and M2 are mainly composed of porous alumina. The difference between the heat shield films M1 and M2 is in film thickness. The film thickness of the heat shield film M1 is from 20 to 60 μm and that of the heat shield film M2 is from 60 to 150 μm.

### CROSS-REFERENCE TO RELATED APPLICATION

The present disclosure claims priority under 35 U.S.C. § 119 to Japanese Patent Applications No. 2018-026201, filed on Feb. 16, 2018. The contents of these applications are incorporated herein by reference in their entirety.

### TECHNICAL FIELD

The present disclosure relates to a compression self-ignited internal combustion engine.

### BACKGROUND

JP2017-155639A discloses a compression self-ignited internal combustion engine in which a heat shield film is formed on a top surface of a piston. This heat shield film is a porous film having countless opening on its surface. This porous film has lower thermal property than that of piston base material with respect to thermal capacity per unit volume and thermal conductivity. A silica film is provided in a part of the surface of the porous film. The silica film is provided in a region with which fuel from a fuel injection valve directly collides.

The region with which the fuel directly collides is able to restate a region with which initial flame generated from the fuel spray contacts. The region with which this initial flame contacts further can be said to a highest temperature region within the top surface of the piston. In such the highest temperature region, the porous film is liable to be deteriorated due to a temperature difference between its surface and inside. In this regard, according to the silica film, it is possible to reinforce the porous film. Therefore, it is possible to suppress the deterioration of the porous film.

However, when such the silica film is formed on the surface of the porous film, the thermal capacity of the whole film increases for the silica film. As the thermal capacity of the whole film increases, it is difficult to decrease gas temperature inside a cylinder at exhaust stroke of the engine. When the gas temperature inside the cylinder becomes difficult to decrease, in-cylinder pressure and exhaust temperature tend to be high. Here, there are upper limit constraints on the in-cylinder pressure and the exhaust temperature. Therefore, if the in-cylinder pressure and the exhaust temperature increase too much, output of the engine will be reduced.

The present disclosure addresses the above described problem, and an object of the present disclosure is, to provide a technology to suppress the gas temperature inside the cylinder from becoming difficult to decrease in the compression self-ignited internal combustion engine in which the heat shield film having low thermal capacity and low thermal conductivity per unit volume is provided on the top surface of the piston.

### SUMMARY

A first aspect of the present disclosure is a compression self-ignited internal combustion engine for solving the problem described above and has the following features.

The engine includes a piston and an injector which is configured to inject fuel toward a top surface of the piston.

A heat shield film is formed all over the top surface.

Thermal capacity per unit volume of the heat shield film is lower than that of base material of the piston and also thermal conductivity of the heat shield film is lower than that of the base material.

The top surface includes a first region including at least an injection region toward which fuel from the injector is injected and a second region including other region than the first region.

The heat shield film formed on the first region is thinner than the heat shield film formed on the second region.

A second aspect of the present disclosure has the following features according to the first aspect.

A cavity is formed in a central portion of the top surface.

The cavity includes a side surface occupying from an opening rim to a deepest portion of the cavity and a bottom surface occupying from the deepest portion to a central portion of the cavity.

The first region is the entire region of the side surface.

The heat shield film formed on the first region has a uniform thickness.

A third aspect of the present disclosure has the following features according to the first aspect.

The heat shield film includes porous alumina having an opening and silica which seals the opening.

The heat shield film formed on the first region has a thickness from 20 to 60 μm.

The heat shield film formed on the second region has a thickness from 60 to 150 μm.

According to the first aspect, heat shield film formed on the first region including at least the injection region toward which fuel from the injector is injected is formed thinner than the heat shield film formed on the second region. If the heat shield film of the first region is thinner than that of the second region, thermal capacity of the whole film becomes smaller than a case where a thick and uniform heat shield film is formed all over the top surface. Therefore, it is possible to suppress the gas temperature inside the cylinder from becoming difficult to decrease, as compared with a case where the thick and uniform heat shield film is formed all over the top surface.

According to the second aspect, the thin and uniform heat shield film is formed on the entire region of the side surface of the cavity. Therefore, it is possible to secure strength of the heat shield film at the side surface, as compared to a case where a thin heat shield film is formed on a part of the side surface and a thick heat shield film is formed on the remaining region of the side surface.

According to the third aspect, it is possible to preferably suppress the gas temperature inside the cylinder from becoming difficult to decrease in a case where the heat shield film includes porous alumina having an opening and silica which seals the opening.

### BRIEF DESCRIPTION OF DRAWINGS

FIG. 1 is a longitudinal section view of a compression self-ignited internal combustion engine according to an embodiment of the present disclosure;

FIG. 2 is a perspective view of a piston of the engine;

FIG. 3 is a longitudinal section view of a heat shield film on the piston;

FIG. 4 is a diagram for showing an example of a relationship between film thickness and improvement rate of fuel consumption of a heat shield film;

FIG. 5 is a diagram for describing an example of a measurement position of film thickness of a heat shield film;

FIG. 6 is a diagram for showing an example of a relationship between film thickness and surface temperature of a heat shield film; and

FIG. 7 is a longitudinal section view of a compression self-ignited internal combustion engine according to another embodiment of the present disclosure.

### DESCRIPTION OF EMBODIMENTS

Hereinafter, embodiments of the present disclosure will be described based on the accompanying drawings. Note that elements that are common to the respective drawings are denoted by the same reference characters and a duplicate description thereof is omitted.

### 1. Explanation of Configuration of Engine

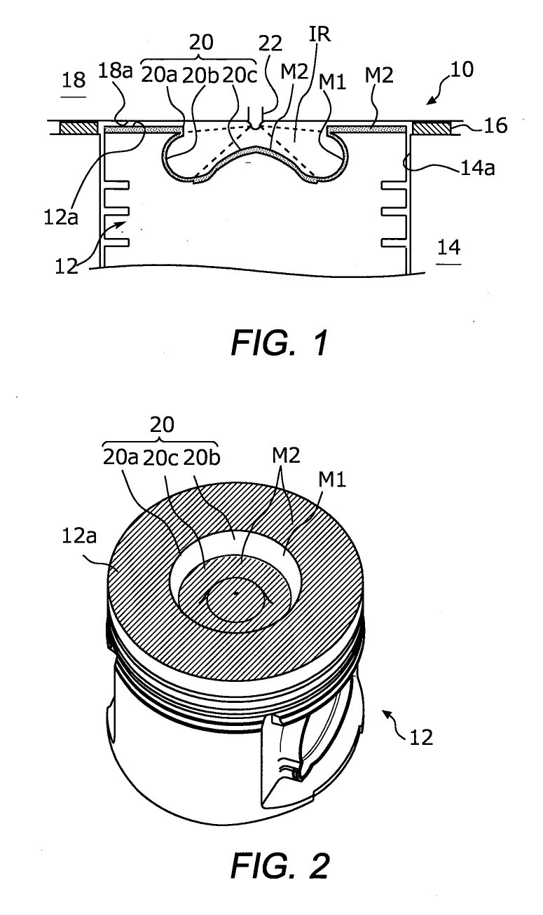

FIG. 1 is a longitudinal section view of a compression self-ignited internal combustion engine (hereinafter also referred to as a “diesel engine”) according to the embodiment. The diesel engine 10 shown in FIG. 1 is a four-stroke type reciprocating engine mounted on a vehicle. As shown in FIG. 1, the diesel engine 10 includes a piston 12, a cylinder block 14, a gasket 16 and a cylinder head 18. A combustion chamber of the diesel engine 10 is defined by at least a top surface 12a of the piston 12, a bore surface 14a of the cylinder block 14 and a bottom surface 18a of the cylinder head 18.

The piston 12 includes a cavity 20 which is formed in a central portion of the top surface 12a. A surface of the cavity 20 also forms a part of the combustion chamber of diesel engine 10. The cavity 20 has an opening rim 20a, a side surface 20b and a bottom surface 20c. The side surface 20b occupies from the opening rim 20a to a deepest portion of the cavity 20. The bottom surface 20c occupies from the deepest portion to a central portion of the cavity 20.

To the cylinder head 18, an injector 22 which is configured to inject fuel directly toward the cavity 20 is attached. A plurality of injection holes are radially formed at a tip portion of the injector 22. In FIG. 1, two injection regions IR are drawn, each of which is formed by two of the injected fuel among the injection holes. In FIG. 1, the piston 12 is located at compression top dead center. The injection region IR is defined based on this compression top dead center.

More specifically, the injection region IR is defined as a diffusion region which is formed by fuel injected in vicinity of the compression top dead center. A border line of the injection region IR intersects with the surface of the cavity 20. The four lines drawn with dotted lines in FIG. 1 correspond to the border lines. Each of the two border lines drawn near the bottom surface 18a is drawn from a center point of the injection hole to a point on the opening rim 20a. Each of the two extension lines near the bottom surface 20c is draw from the center of the injection hole to a point at a border of the side face 20b and the bottom face 20a. That is, the injection region IR is set within the side surface 20b.

FIG. 2 is a perspective view of the piston 12 shown in FIG. 1. As shown in FIG. 2, a heat shield film M1 is formed on entire area of the side surface 20b. On the other hand, a heat shield film M2 is formed on entire area of the top surface 12a and the bottom surface 20c. The heat shield films M1 and M2 are mainly composed of porous alumina. Base material of the piston 12 is aluminum alloy. The porous alumina is a so-called anodic oxidation film formed by anodization of this base material.

### 2. Composition of Heat Shield Film

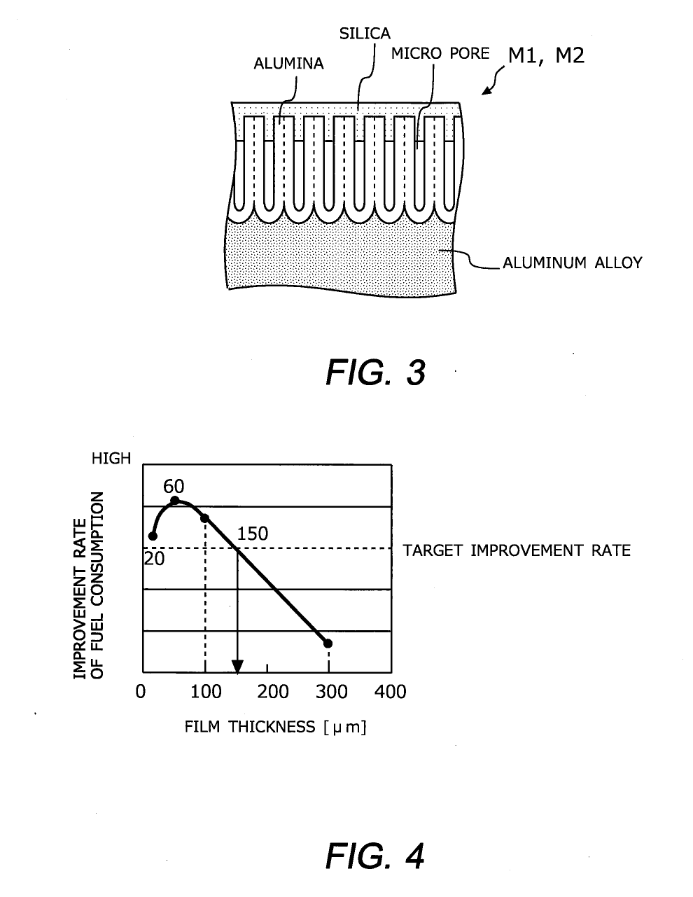

FIG. 3 is a diagram for describing a configuration of the heat shield films M1 and M2. As shown in FIG. 3, the heat shield films M1 and M2 have a large number of pores, each of which is formed from film's boundary with aluminum alloy to film's surface. Their openings are sealed by silica film. The silica film is formed by sealing treatment using a silicon-based polymer solution (i.e., a solution containing a silica component such as polysilazane or polysiloxane). In the sealing treatment, a part of the silicon-based polymer solution which was applied on the surface of porous alumina enters inside of the opening and then solidifies. Therefore, silica and porous alumina are integrated thereby a boundary between them is not always clear.

The heat shield films M1 and M2 shown in FIG. 3 have lower thermal properties in thermal conductivity and thermal capacity per unit volume than the piston base material (i.e., aluminum alloy) and any one of a conventional heat shield film composed of ceramics. Therefore, according to the diesel engine with the heat shield films M1 and M2, it is possible to make surface temperature of these heat shield films follow gas temperature inside the combustion chamber. That is, in an expansion stroke of an engine cycle, it is possible to follow the surface temperature to the gas temperature and reduce cooling loss. Further, in the next intake stroke, it is possible to follow the surface temperature to the gas temperature and suppress occurrence of abnormal combustion.

Herein, a difference between the heat shield films M1 and M2 is in film thickness. The film thickness of the heat shield film M1 is smaller than that of the heat shield film M2. More specifically, the film thickness of the heat shield film M1 is from 20 to 60 μm, and that of the heat shield film M2 is from 60 to 150 μm. Their film thickness of the heat shield films M1 and M2 are preferably uniform. This is because that if a film thickness of a heat shield film is uniform, it is possible to suppress a distribution bias of the surface temperature of the heat shield film. Also, if the film thickness of the heat shield film is uniform, it is possible to increase strength of the heat shield film as compared with a case where the film thickness is not uniform.

Ranges of the film thickness of the heat shield films M1 and M2 are set based on improvement rate of fuel consumption shown in FIG. 4. FIG. 4 is a diagram for showing an example of a relationship between the improvement rate of fuel consumption of a diesel engine and film thickness of a heat shield film. The vertical axis of FIG. 4 (i.e., improvement rate of fuel consumption) represents the fuel consumption rate of an engine with a heat shield film composed of porous alumina and silica while using the fuel consumption rate of an engine without the heat shield film as a standard.

As shown in FIG. 4, the improvement rate of fuel consumption increases as the film thickness increases in a region where the film thickness is 20 μm or more and 60 μm or less. On the other hand, in a region where the film thickness is 60 μm or more, the improvement rate of fuel consumption decreases as the film thickness increases. In a region where the film thickness is larger than 150 μm, the improvement rate of fuel consumption is lower than that at 20 μm. Therefore, in the present embodiment, 20 μm is set as a lower limit of the film thickness, and 150 μm is set as an upper limit of the film thickness.

### 3. Formation Example of Heat Shield Film

The heat shield films M1 and M2 whose film thickness are different are formed, for example, by making a difference in time of the anodization. In general, the longer the anodization time is performed, the larger the film thickness becomes. Therefore, in this example, at first, the anodization is performed on the top surface 12a while masking the side face 20b. Thereby, porous alumina is formed on the top surface 12a other than the side surface 20b. Subsequently, this masking is removed and the anodization is performed on entire area of the top surface 12a. In this way, porous alumina having a smaller film thickness than its surroundings is formed on the side surface 20b. Subsequently, smoothing treatment is performed to align the porous alumina's height, and then opening sealing treatment is performed. Through the above processes, the heat shield films M1 and M2 with different film thickness are obtained.

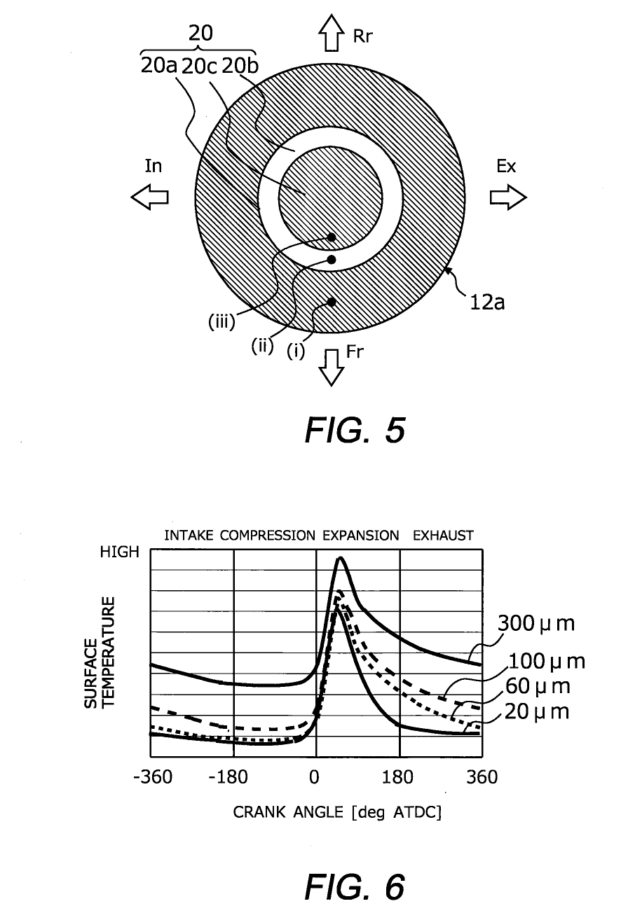

The film thickness of the heat shield films M1 and M2 are measured using an overcurrent type film thickness meter. FIG. 5 is a diagram for describing an example of a measurement position of the film thickness. In FIG. 5, three points are drawn on the front side (Fr). The thickness is measured at the first point (i) on the top surface 12a, the second point (ii) on the side surface 20b and the third point (iii) on the bottom surface 20c). The film thickness at each measurement point is measured 3 to 5 times, and average value of each measurement point is defined as the film thickness. Preferably, the film thickness is measured not only on the front side but also on the rear side (Rr), the intake side (In) and the exhaust side (Ex). By measuring at these locations, it is possible to confirm of the uniformity of the film thickness.

### 4. Effect According to Heat Shield Films M1 and M2

As already described, according to the thermal properties of the heat shield films M1 and M2, it is possible to make the surface temperature of these heat shield films follow the gas temperature inside the combustion chamber. However, if the film thickness of the heat shield films are too large, there is a case where the improvement rate of fuel consumption falls below a target value (see FIG. 4). Focusing on this point, the inventor of the present disclosure investigated a relationship between surface temperature of a heat shield film and film thickness of the heat shield film. The result of this investigation is shown in FIG. 6. As shown in a crank angle range corresponding to the expansion stroke (i.e., from 0 to 180 ATDC), when the film thickness of the heat shield film becomes larger, maximum value of the surface temperature becomes higher.

However, as shown in a crank angle range corresponding to the exhaust stroke (i.e., from 180 to 360 ATDC), when the film thickness of the heat shield film becomes larger, the surface temperature of the heat shield film becomes hard to lower in the exhaust stroke. Therefore, even when low temperature gas (i.e., fresh air) flows into the combustion chamber in the intake stroke following the exhaust stroke, it is difficult to sufficiently lower the surface temperature of the heat shield film during the intake stroke. From such a result, the present inventors speculated that the decrease in the improvement rate of fuel consumption in the region where the film thickness is 60 μm or more (see FIG. 4) is caused by an increase in thermal capacity of the whole film due to an increase in the film thickness.

Regarding this problem, the heat shield film M1 is formed on a region with which initial flame generated from the injected fuel from the injector 22 collides. Therefore, it is expected that the maximum value of the surface temperature in the side surface 20b reaches a high temperature. In this regard, according to this embodiment, since the film thickness of the heat shield film M1 is set from 20 to 60 μm, it is possible to reduce the thermal capacity of the heat shield film M1. Therefore, it is possible to, in the heat shield film M1, prevent the maximum value of the surface temperature from rising excessively. However, if the thickness of the heat shield film M2 is set like that of the heat shield film M1, the maximum value of the surface temperature of the heat shield film M2, which is expected to be relatively low, also decreases. In this regard, according to this embodiment, since the film thickness of the heat shield film M2 is set from 60 to 150 μm, it is possible to enhance the heat insulation performance of the heat shield film as a whole. Therefore, it is possible to improve output of the diesel engine.

In the embodiment described above, the region of the side surface 20b corresponds to the “first region” of the first aspect and the region of the top surface 12a excluding the side surface 20b corresponds to the “second region” of the first aspect.

### 5. Other Embodiments

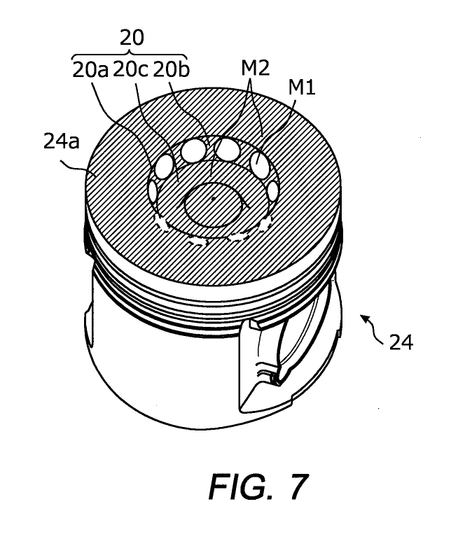

In the embodiment described above, the heat shield film M1 was formed on the entire area of the side surface 20b. However, the heat shield film M1 may not be formed on the entire area. FIG. 7 is a longitudinal section view of a piston 24 in which the heat shield film M1 is formed on a part of a side surface 20b. As shown in FIG. 7, the heat shield film M1 is formed in a circular region (total 10 regions) of the side surface 20b. The heat shield film M2 is formed on the top surface 24a of the piston 24, the bottom surface 20c and the side surface 20b excluding the circular region with the heat film M1. The circular region is a region corresponding to the injection region IR described above.

In the embodiment described above, the heat shield film composed of porous alumina and silica was applied to the diesel engine. However, a film obtained by thermal spraying ceramics such as zirconia (ZrO2), silica (SiO2), silicon nitride (Si3N4), yttria (Y2O3) and titanium oxide (TiO2) may be applied as the heat shield film. The sprayed film has equivalent thermal properties to porous alumina. Therefore, the relationship described in FIG. 4 is predicted to be established in the sprayed film.

Therefore, when such a sprayed film is applied, film thickness of the sprayed film formed on the entire area of the side face 20b (or the region corresponding to the injection region IR) and that on the region other than the side face 20b may be set as follows. Specifically, first, for each sprayed film, the relationship shown in FIG. 4 is obtained and maximum value of the improvement rate of fuel consumption is specified. Subsequently, a film thickness range thinner than a film thickness corresponding to the maximum value is set as a film thickness of the sprayed film on the entire area of the side face 20b. Also, in a film thickness range thicker than the film thickness corresponding to the maximum value, an upper limit of the film thickness is set based on the target value of the improvement rate of fuel consumption. Then, a range from the upper limit to the film thickness corresponding to the maximum value is set as a film thickness of the sprayed film on the area other than the side face 20b.

What is claimed is:

1. A compression self-ignited internal combustion engine, comprising:
a piston; and
an injector which is configured to inject fuel toward a top surface of the piston,
wherein:
a heat shield film is formed all over the top surface;
the thermal capacity per unit volume of the heat shield film is lower than that of base material of the piston and also thermal conductivity of the heat shield film is lower than that of the base material;
the top surface includes a first region including at least an injection region toward which fuel from the injector is injected and a second region including other region than the first region; and
the heat shield film formed on the first region is thinner than the heat shield film formed on the second region.

2. The compression self-ignited internal combustion engine according to claim 1, wherein:
a cavity is formed in a central portion of the top surface;
the cavity includes a side surface occupying from an opening rim to a deepest portion of the cavity and a bottom surface occupying from the deepest portion to a central portion of the cavity;
the first region is the entire region of the side surface; and
the heat shield film formed on the first region has a uniform thickness.

3. The compression self-ignited internal combustion engine according claim 1, wherein:
the heat shield film includes porous alumina having an opening and silica which seals the opening;
the heat shield film formed on the first region has a thickness from 20 to 60 μm; and
the heat shield film formed on the second region has a thickness from 60 to 150 μm.
